(19) United States
(12) Patent Application Publication
(10) Pub. No.: US 2018/0370003 A1
(43) Pub. Date: Dec. 27, 2018

(54) DRIVER DEVICE OPERATED BY MEANS OF COMBUSTIBLE GAS

(71) Applicant: Hilti Aktiengesellschaft, Schaan (LI)

(72) Inventor: Dominik SCHMIDT, Buchs (CH)

(21) Appl. No.: 15/781,738

(22) PCT Filed: Dec. 7, 2016
(86) PCT No.: PCT/EP2016/079976

§ 371 Date: Jun. 6, 2018

(30) Foreign Application Priority Data
Dec. 18, 2015 (EP) 15201045.0

(51) Int. Cl. B25C 1/08; B25C 1/00

(52) U.S. Cl. CPC B25C 1/08; B25C 1/008

(57) ABSTRACT

The invention relates to a driver device, comprising a driving piston for driving a nail element into a workpiece, which driving piston is guided in a cylinder, and comprising a combustion chamber arranged adjoining the driving piston. In the course of a driving process, a pressure increase occurs in the combustion chamber as a result of a combustion process. Before the driving process, the driving piston is held in an initial position by means of a piston holder. The piston holder comprises a piezoelectric actuator.

The invention relates to a driver device, in particular a handheld driver device, according to the preamble of claim 1. The invention moreover relates to an operating method for a driver device according to the features of claim 10.

In general, the invention relates to driver devices, in which a driving piston is accelerated by a rapidly expanding gas in the scope of a combustion process. Typical constructions of such devices use powder cartridges or an ignitable combustible gas mixture for this purpose. Driver devices of such constructions are regularly designed for high driving energies.

EP 1 987 924 A1 describes a chargeable driver device operated by means of combustible gas, in which a driving piston is held by means of a holding device in a starting position. The holding device comprises a ball head, which engages in a channel formed on the driving piston in the radial direction and to which a force is applied. In one embodiment, the driving piston can be released by activating an electromagnetic coil. The holding device is used for supporting the piston against a charging pressure of the combustible gas in the combustion chamber, which is already applied before an ignition.

It is the object of the invention to specify a driver device which enables a secure hold and a rapid release of the driving piston.

This object is achieved for a driver device of the type mentioned at the outset according to the invention by the characterizing features of claim 1. By providing a piezoelectric actuator in the piston holder, the release can take place at a selected point in time by means of an electrical voltage, wherein the release can take place nearly without delay because of the high reaction speed of piezoelectric actuators.

A piezoelectric actuator is understood in the meaning of the invention as any component which uses the inverse piezoelectric effect of a length change by applying a voltage to a piezoelectric solid body. The length change is used in this case in the meaning of a mechanical actuator, by which a state of the piston holder is changed. Depending on the mechanical design, a release of the piston can preferably be performed in this case by turning on, but if needed also by turning off the voltage. Frequently used piezoelectric actuators comprise a piezoceramic as a piezoelectrically active solid body and are generally constructed from a plurality of contacted layers.

In general, it is understood that the piston holder of a driver device according to the invention preferably comprises two or more piezoelectric actuators distributed around the circumference of the piston, to ensure a low-torsion and particularly secure hold.

In a generally preferred embodiment, the piston holder comprises a bolt element, which is actuatable by means of the piezoelectric actuator, for the preferably formfitting holding of the driver piston. A bolt element, in particular in conjunction with a formfitting holder, enables a secure hold of the piston even in relation to high pressure. It is particularly preferably provided in this case that the piezoelectric actuator acts via a gearing on the bolt element. This enables a significantly enlarged stroke in relation to the piezoelectric actuator and thus an adaptation to the mechanically and thermally related tolerances of routine driving pistons.

A gearing is understood in particular as a lever gearing. The gearing generally preferably supplies a significant transmission ratio of the length change of the piezoelectric actuator, preferably by a factor of more than two.

The piezoelectric actuator is generally advantageously supported against the force of a pre-tension spring, whereby an accurate function, which is free of play, of the piston holder is enabled.

In one particularly preferred embodiment of the invention, a release of the driving piston by means of the piezoelectric actuator takes place with a time delay after an ignition process. This enables the targeted release of the driving piston after a pressure buildup which has already occurred, whereby the energy transfer to the driving piston and thus the achievable setting energy can be elevated. The chronological accuracy and the speed of the release are necessarily very high in this case and can be achieved by the use of piezoelectric actuators according to the invention.

The release generally preferably takes place in this case as a function of a pressure threshold, a temperature threshold, or a defined time interval. Furthermore, the time delay is preferably moreover variably settable. For example, the change of the delay can be performed by automatic or manual preselection of a value. Automated tracking of the delay depending on the sequence of a preceding driving process can also be provided.

Overall, optimization of the driving process is achieved in this way, and therefore the highest possible setting energy is achievable and/or the setting energy can be set by selecting the delay.

In one generally advantageous embodiment, the combustion chamber is fillable with an ignitable combustible gas mixture. Such driver devices operated using combustible gas achieve high energies with little soiling of the device mechanism as a result of burn-off products. In one particularly preferred embodiment, an overpressure of the combustible gas mixture in the combustion chamber can be generated in this case by means of a charging element.

An overpressure of the combustible gas mixture is understood in this case as an elevated pressure to increase the driving energy. The pressure of the combustible gas mixture is also usually somewhat above an ambient pressure in conventional, non-charged devices, since the pressurized combustible gas is added to the air under atmospheric pressure in the combustion chamber. This is only a slight pressure increase in this case. An overpressure in the meaning of the invention is preferably at least 100 mbar, particularly preferably at least 200 mbar above atmospheric pressure.

The object of the invention is moreover achieved by a method for operating a driver device, comprising the following steps:

a. holding a driving piston in a starting position by means of a piston holder;

b. igniting a combustion process in a combustion chamber while elevating a pressure acting on the driving piston;

c. releasing the driving piston by means of an electrical signal at the piston holder, after a defined pressure increase has taken place.

Due to the delayed release of the piston holder, the resulting driving energy can be intentionally changed and in particular a high maximum driving energy can be achieved.

The method according to the invention is preferably carried out by means of an above-described driver device according to the invention.

Further advantages and features of the invention result from the exemplary embodiment described hereafter and from the dependent claims.

An exemplary embodiment of the invention will be described hereafter and explained in greater detail on the basis of the appended drawings.

FIG. 1 shows a schematic sectional view of a driver device according to the invention.

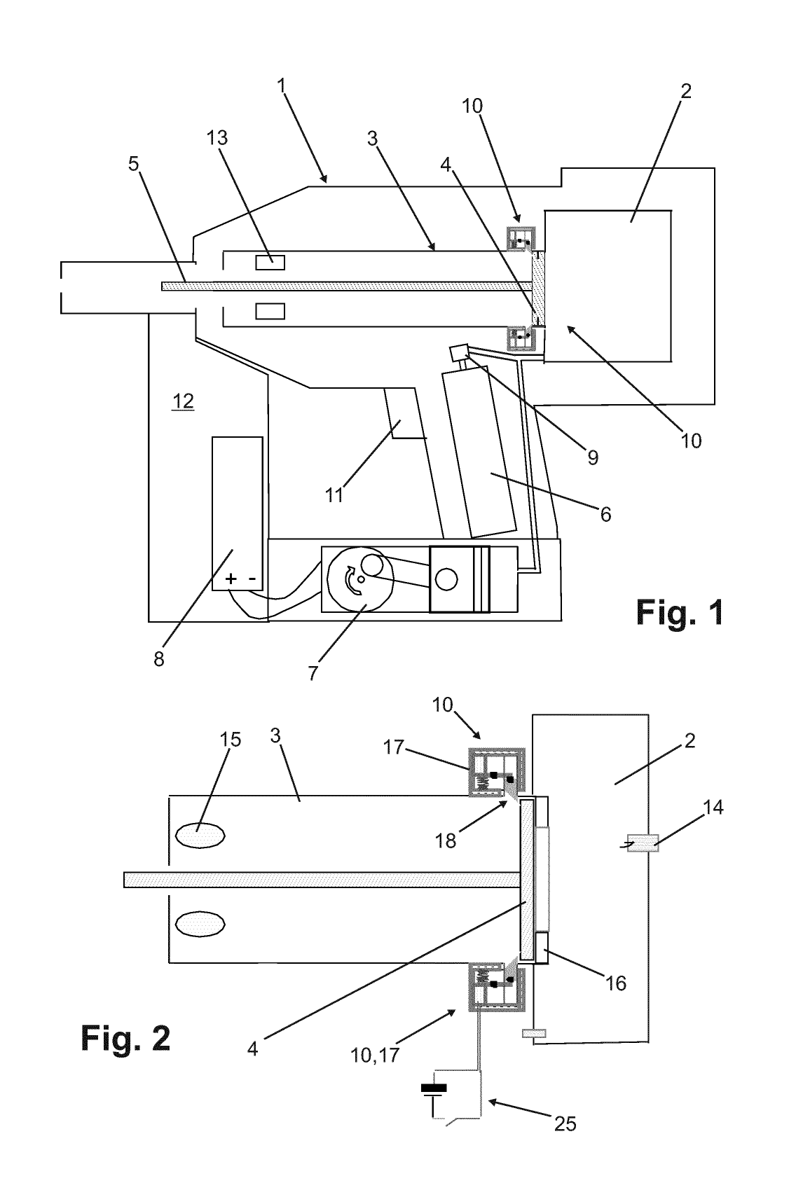

FIG. 2 shows a schematic detail view of the driver device from FIG. 1 before the triggering of a driving process having closed piston holder.

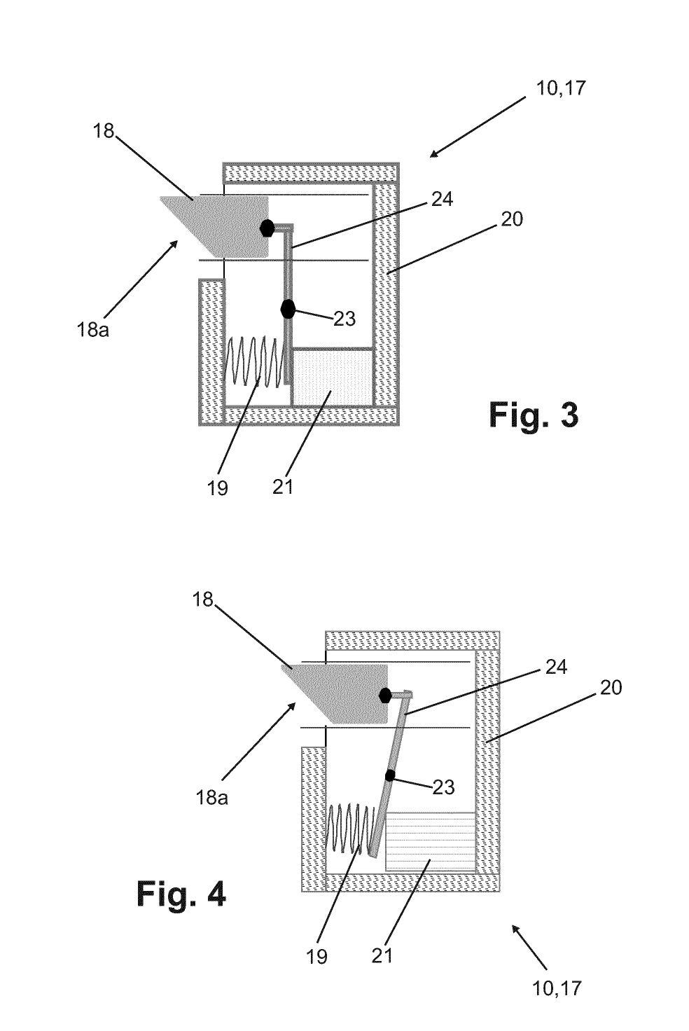

FIG. 3 shows a schematic detail illustration of the piston holder from FIG. 2.

FIG. 4 shows the piston holder from FIG. 3 in an open state.

The driver device from FIG. 1 is a handheld device, comprising a housing 1 and a combustion chamber 2 accommodated therein having a combustion chamber wall. A cylinder 3 having a driving piston 4 guided therein adjoins the combustion chamber 2. The driving piston 4 comprises a driving tappet 5 for driving a nail element (not shown) into a workpiece.

An ignitable combustible gas mixture is introduced in the present case by means of a combustible gas store 6 into the combustion chamber 2. The combustible gas mixture is compressed to an overpressure in this case by means of a charging element 7. The charging element is designed as an electrically driven compressor supplied via a rechargeable battery 8. In other embodiments, charging can also take place by means of a driven reset of the driving piston 4 or in another manner.

The combustible gas is introduced via a metering valve 9 from the combustible gas store 6 into the air of the combustion chamber 2. The combustible gas injection can take place depending on the requirements in the not yet compressed, partially compressed, or also completely compressed air.

In the completely reset state (see FIG. 1), the driving piston 4 is held by a piston holder 10 against the overpressure in the combustion chamber.

With charged combustion chamber, via a manually-actuated trigger 11, an ignition of the combustible gas mixture can then be triggered via a spark plug 14, and therefore the driving piston 4 is driven forward and drives the nail element (not shown) from a magazine 12 into the workpiece via the driving tappet 5. The exhaust gases of the ignited and expanded combustible gas can enter the exterior at the end of the travel of the driving piston via outlet openings 13. The driving piston strikes against stop cushions 15 (shown in FIG. 2) at the end of its travel. During a reset of the piston, its travel is delimited by an upper stop 16 at the outlet of the combustion chamber 2.

In a starting state before an ignition of the combustible gas, the driving piston 4 is held by means of the piston holder 10 in its starting position. The piston holder 10 comprises multiple, in the present case two, similarly constructed holding elements 17, which are arranged distributed around the circumference of the cylinder 3. Each of the holding elements has a bolt element 18 movable essentially radially in relation to the cylinder.

The bolt element 18 has a bevel 18a in each case on the side facing away from the held piston. During a reset, the driving piston can press back the bolt element 18a against the force of a spring 19 by traveling over the bevel. After it is traveled over, the bolt element 18 snaps back radially into the cylinder 3 in each case, and therefore the non-beveled side of the bolt element 18 holds the driving piston in a formfitting manner against the pressure in the combustion chamber 2 in the starting position.

The holding elements 17 each comprise a housing 20, in which the bolt element 18 is mounted so it is displaceable. Moreover, a piezoelectric actuator 21 is accommodated in the housing, which is mechanically coupled to the bolt element 18 via a gearing 22.

The gearing 22 is illustrated schematically in the present case as a lever 24 mounted in a pivot point 23. A first end of the lever 24 engages at the bolt element 18 and a second, opposing end of the lever 24 is supported on the piezoelectric actuator 21 and on the spring 19. The spring 19 presses the lever 24 against the piezoelectric actuator in this case and in the direction of a closing movement of the bolt element 18.

A voltage can be applied to the piezoelectric actuator 21 by means of a voltage source 25. The voltage source 25 is supplied centrally with energy by the rechargeable battery 8, but generates a sufficiently high voltage for deflecting the piezoelectric actuator 21. The electrical components of the driver device, such as the rechargeable battery 8 and the voltage source 25, are connected to an electronic control unit (not shown) of the driver device.

FIG. 3 shows one of the holding elements 17 in a closed position, in which the bolt element 18 is extended beyond the wall of the cylinder 3 and fixes the driving piston 4. Voltage is not applied to the piezoelectric actuator 21 in this position and it is accordingly shortened.

FIG. 4 shows the holding elements 17 upon application of a voltage by the voltage source 25. The piezoelectric actuator 21 has become longer due to the inverse piezoelectric effect and presses in the lever 24 against the spring 19. The bolt element 18 is retracted behind the wall of the cylinder 3 in accordance with the deflection function of the lever 24 and releases the driving piston 4.

The invention functions as follows:

The piezoelectric actuators 21 are deenergized in the starting position of the driving piston 4 held in a formfitting manner. The combustion chamber is charged with combustible gas and accordingly is ignitable. As soon as the trigger 11 is actuated and further safety parameters, such as a placement of the device against a workpiece, are fulfilled, the ignition is triggered by means of an electrical spark at the spark plug. This defines the starting point in time of a timer.

After passage of a predefined time span, the combustion process has progressed enough that a substantially higher pressure has already built up in the combustion chamber 2. The combustion process is generally not yet completed in this case, since this would in turn mean an excessively high pressure.

After passage of the predefined time span, the piezoelectric actuators 21 are connected to electrical voltage and the piston holder releases the driving piston within a very short time span. The driving piston is subsequently accelerated by means of the applied pressure and the further pressure elevation due to the progressing combustion process.

A piston holder according to the invention is also advantageously usable in principle without a defined pressure increase, however, and therefore a piston release simultaneous with the ignition of the combustible gas mixture can also be provided.

In this example, a pressure increase was defined by the selection of the predefined time span or delay, which means a corresponding approximation and presumes sufficient reproducibility of the combustion process. In other embodiments, sensorially detected variables such as pressure and/or temperature in the combustion chamber 2 can also be used as the criterion for the release of the piston holder. The predefined time span and/or corresponding threshold values of measured variables can be changed in reasonable ranges to vary the driving energy as needed.

1. A driver device, comprising
a driving piston guided in a cylinder for driving a nail element into a workpiece;
a combustion chamber arranged adjoining the driving piston, in which a pressure increase takes place due to a combustion process during a driving process; and,
a piston holder;
wherein the driving piston is held in a starting position before the driving by the piston holder, wherein, the piston holder comprises a piezoelectric actuator.

2. The driver device as claimed in claim 1, wherein the piston holder comprises a bolt element actuatable by the piezoelectric actuator.

3. The driver device as claimed in claim 2, wherein the piezoelectric actuator acts via a gearing on the bolt element.

4. The driver device as claimed in claim 1, wherein the piezoelectric actuator is supported against a force of a pre-tension spring.

5. The driver device as claimed in claim 1, wherein a release of the driving piston by the piezoelectric actuator takes place with a time delay after an ignition process.

6. The driver device as claimed in claim 5, wherein the release takes place depending on a pressure threshold, a temperature threshold, or a defined time interval.

7. The driver device as claimed in claim 5, wherein the time delay is variably settable.

8. The driver device as claimed in claim 1, wherein the combustion chamber is fillable with an ignitable combustible gas mixture.

9. The driver device as claimed in claim 8, wherein an overpressure of the combustible gas mixture in the combustion chamber can be generated by a charging element.

10. A method for operating the driver device of claim 1, comprising:
a. holding a driving piston in a starting position by a piston holder;
b. igniting a combustion process in a combustion chamber while elevating a pressure acting on the driving piston; and
c. releasing the driving piston by means fan electrical signal at the piston holder after a defined pressure increase has taken place.

11. The driver device as claimed in claim 2, wherein the piezoelectric actuator is supported against a force of pre-tension spring.

12. The driver device as claimed in claim 3, wherein the piezoelectric actuator is supported against a force of pre-tension spring.

13. The driver device as claimed in claim 2, wherein a release of the driving piston by the piezoelectric actuator takes place with a time delay after an ignition process.

14. The driver device as claimed in claim 3, wherein a release of the driving piston by the piezoelectric actuator takes place with a time delay after an ignition process.

15. The driver device as claimed in claim 4, wherein a release of the driving piston by the piezoelectric actuator takes place with a time delay after an ignition process.

16. The driver device as claimed in claim 13, wherein the release takes place depending on a pressure threshold, a temperature threshold, or a defined time interval.

17. The driver device as claimed in claim 14, wherein the release takes place depending on a pressure threshold, a temperature threshold, or a defined time interval.

18. The driver device as claimed in claim 15, wherein the release takes place depending on a pressure threshold, a temperature threshold, or a defined time interval.

19. The driver device as claimed in claim 2, wherein the combustion chamber is fillable with an ignitable combustible gas mixture.

20. The driver device as claimed in claim 3, wherein the combustion chamber is fillable with an ignitable combustible gas mixture.
